(19) United States
(12) Patent Application Publication
(10) Pub. No.: US 2026/0140062 A1
(43) Pub. Date: May 21, 2026

(54) SECONDARY BATTERY INSPECTION DEVICE

(71) Applicants: Samsung SDI Co., Ltd, Yongin-si (KR); HB Technology CO., LTD., Asan-si (KR)

(72) Inventors: Il Joon Park, Suwon-si (KR); Dong Su Choi, Suwon-si (KR); Jang Hyo Lee, Suwon-si (KR); Sung Min Cho, Suwon-si (KR); Seul Ong Choi, Suwon-si (KR); Do Kyong Park, Asan-si (KR)

(73) Assignees: Samsung SDI Co., Ltd, Yongin-si (KR); HB Technology CO., LTD., Asan-si (KR)

(21) Appl. No.: 19/360,296

(22) Filed: Oct. 16, 2025

(30) Foreign Application Priority Data
Nov. 18, 2024 (KR) 10-2024-0164222

(51) Int. Cl. G01N 21/88; G01N 21/95

(52) U.S. Cl. CPC G01N 21/8806; G01N 21/8851; G01N 21/95

(57) ABSTRACT

The present disclosure relates to a secondary battery inspection device and provides a secondary battery inspection device including a photographing unit photographing a dummy battery cell, a lighting unit disposed between the photographing unit and the dummy battery cell and irradiating light toward the dummy battery cell, and an angle adjustment unit disposed between the lighting unit and the dummy battery cell and coming into contact with the lighting unit to adjust an irradiation angle of the lighting unit.

### CROSS-REFERENCE TO RELATED APPLICATIONS

This present application claims priority to and the benefit under 35 U.S.C. § 119 (a)-(d) of Korean Patent Application No. 10-2024-0164222, filed on Nov. 18, 2024, in the Korean Intellectual Property Office, the entire disclosure of which is incorporated herein by reference.

### FIELD

The present disclosure relates to a secondary battery inspection device.

### BACKGROUND

Generally, recently, the demand for secondary batteries with high energy density and high capacity is rapidly increasing with the rapid supply of electronic devices using batteries, such as mobile phones, notebook computers, electric vehicles, and the like. Accordingly, research and development to improve the performance of lithium secondary batteries is actively being conducted.

A lithium secondary battery is a battery that includes a positive electrode and a negative electrode including active materials capable of intercalation and deintercalation of lithium ions, and an electrolyte, and produces electrical energy through oxidation and reduction reactions when lithium ions are intercalated/deintercalated into/from the positive electrode and negative electrode.

The herein-described information disclosed in the background technology of this disclosure is only intended to improve understanding of the background of the present disclosure and therefore may include information that does not constitute related art.

### SUMMARY

The present disclosure is directed to providing a secondary battery inspection device capable of inspecting an appearance of a secondary battery by photographing the secondary battery.

However, technical problems to be solved by the present disclosure are not limited to the problems described herein, and other problems not mentioned can be clearly understood by those skilled in the art from the description of the disclosure described herein.

According to aspects of the present disclosure, there is provided a secondary battery inspection device including a photographing unit photographing a dummy battery cell, a lighting unit disposed between the photographing unit and the dummy battery cell and irradiating light toward the dummy battery cell, and an angle adjustment unit disposed between the lighting unit and the dummy battery cell and coming into contact with the lighting unit to adjust an irradiation angle of the lighting unit.

The lighting unit may include a lighting main body disposed to face the angle adjustment unit in a direction substantially parallel to a first direction and supported by the photographing unit and a lamp rotatably coupled to the lighting main body.

The lamp may include a first lamp and a second lamp disposed to be spaced apart from the first lamp in a direction substantially parallel to a second direction intersecting the first direction.

The lamp may further include a third lamp disposed to intersect the first lamp and the second lamp and a fourth lamp disposed to be spaced apart from the third lamp in a direction substantially parallel to a third direction intersecting the first direction and the second direction.

The angle adjustment unit may include an angle adjustment main body disposed to face the lighting main body and an angle adjustment block movably coupled to the angle adjustment main body and contactable with the lamp.

The angle adjustment main body may be provided with a first scale indicating a movement distance of the angle adjustment block.

The angle adjustment block may be provided with an angle adjustment surface that comes into contact with the lamp to adjust a rotation angle of the lamp.

The angle adjustment surface may be formed obliquely on an outer surface of the angle adjustment block.

The angle adjustment block may include a first block and a second block disposed to be spaced apart from the first block in a direction substantially parallel to a second direction intersecting the first direction.

The first block and the second block may protrude from the angle adjustment main body in a direction substantially parallel to the second direction.

The angle adjustment block may further include a third block disposed to intersect the first block and the second block and a fourth block disposed to be spaced apart from the third block in a direction substantially parallel to a third direction intersecting the first direction and the second direction.

The third block and the fourth block may protrude from the angle adjustment main body in a direction substantially parallel to the third direction.

The secondary battery inspection device may further include a position adjustment unit connected to the dummy battery cell and interfering with the photographing unit to adjust a position of the photographing unit.

The photographing unit may include a photographing main body supporting the lighting unit and a camera movably coupled to the photographing main body in a direction substantially parallel to a first direction.

The position adjustment unit may include a first frame coupled to the photographing main body, a second frame connected to the first frame and coupled to the dummy battery cell, and a third frame disposed to be spaced apart from the second frame, movably coupled to the first frame in a direction substantially parallel to the first direction, and contactable with the camera.

The first frame may be provided with a second scale indicating a movement distance of the third frame.

### BRIEF DESCRIPTION OF THE DRAWINGS

The following drawings attached to the present specification illustrate exemplary embodiments of the present disclosure and further describe aspects and features of the present disclosure together with the detailed description of the present disclosure. Thus, the present disclosure should not be construed as being limited to the drawings, in which:

FIG. 1 is a perspective view schematically illustrating a configuration of a secondary battery inspection device according to embodiments of the present disclosure;

FIG. 2 is a plan view schematically illustrating a configuration of the secondary battery inspection device according to embodiments of the present disclosure;

FIG. 3 is a perspective view schematically illustrating a configuration of an angle adjustment unit according to embodiments of the present disclosure;

FIG. 4 is a front view schematically illustrating a configuration of the angle adjustment unit according to embodiments of the present disclosure;

FIG. 5 is a perspective view schematically illustrating a configuration of the secondary battery inspection device according to embodiments of the present disclosure;

FIG. 6 is a perspective view schematically illustrating a configuration of a position adjustment unit according to embodiments of the present disclosure;

FIG. 7 is a partially enlarged perspective view schematically illustrating a configuration of the position adjustment unit according to embodiments of the present disclosure;

FIG. 8 is a plan view schematically illustrating a configuration of the position adjustment unit according to embodiments of the present disclosure; and

FIG. 9 is a side view schematically illustrating a configuration of the position adjustment unit according to embodiments of the present disclosure.

### DETAILED DESCRIPTION

Hereinafter, exemplary embodiments of the present disclosure will be described in detail with reference to the attached drawings. Prior to this, terms or words used in this specification and claims should not be interpreted limited to ordinary or dictionary meanings and should be interpreted as meanings and concepts consistent with the technical idea of this disclosure based on the principle that the inventor can properly define the concept of the term in order to describe his or her disclosure in the best way. Accordingly, it is to be understood that the embodiments described herein, and the configurations illustrated in the drawings are only some of the most exemplary embodiments of the disclosure and do not represent all of the technical ideas of the disclosure, and that there may be various equivalents and modifications that may replace them at the time of filing.

Furthermore, when used herein, the terms “comprise or include” and/or “comprising or including” specify the presence of the mentioned shapes, numbers, steps, operations, members, elements, and/or groups thereof and are not intended to exclude the presence or addition of one or more other shapes, numbers, operations, members, elements, and/or groups thereof.

In addition, in order to help understand the disclosure, the attached drawings are not drawn to actual scale, and the dimensions of some components may be exaggerated. In addition, the same reference numbers may be assigned to the same components in different embodiments.

The statement that two objects for comparison are ‘equal’ means ‘substantially the same.’ Therefore, substantially the same may include deviations that are considered low in the art, for example, deviations of less than 5%. Additionally, uniformity of a parameter over a given region may imply uniformity from an average perspective.

Although first, second, and the like are used to describe various components, the components are not limited by these terms. These terms are used only to distinguish one component from another, and unless otherwise specifically stated, it is to be understood that a first component may also be a second component.

Throughout the specification, unless otherwise specifically stated, each element may be singular or plural.

When an arbitrary configuration is placed “on (or under)” a component or “above (or below)” a component, it can mean not only that the arbitrary configuration is placed in contact with the top (or bottom) of the component, but also that other configurations can be interposed between the component and the arbitrary configuration placed on (or under) the component.

In addition, when a component is described as being “on,” “connected to,” or “coupled to” in another component, the above components may be directly connected or coupled to each other, but it should be understood that other components may be “interposed” between each component, or each component may be “connected,” “coupled,” or “linked” through another component.

As used herein, the term “and/or” includes any and all combinations of one or more of the associated listed items. Further, the use of “may” when describing embodiments of the present disclosure relates to “one or more embodiments of the present disclosure.”. Equations such as “one or more” and “one or more” before the list of elements modify the entire list of elements and do not modify individual elements in the list.

Throughout the specification, “A and/or B” means A, B, or A and B unless otherwise stated to the contrary. That is, “and/or” includes any or all combinations of a plurality of listed items. When “C to D” is stated, it means greater than or equal to C and less than or equal to D unless otherwise specifically stated.

When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C.

The term “use” may be considered synonymous with the term “utilize.” As used herein, the terms “substantially,” “about,” and similar terms are used as terms of approximation, not as terms of degree, and are intended to take into account inherent variations in measured or calculated values that would be recognized by a person of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed herein could be named a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the drawings. It will be understood that the spatially relative terms are intended to encompass different orientations of the device in use or operation in addition to the orientation depicted in the drawings. For example, if the device in the figures is turned over, elements described as “below” or “beneath” other elements or features would then be oriented “above” or “over” the other elements or features. Thus, the term “below” may encompass both an orientation of above and below.

The terminology used herein is for the purpose of describing embodiments of the present disclosure and is not intended to limit the present disclosure.

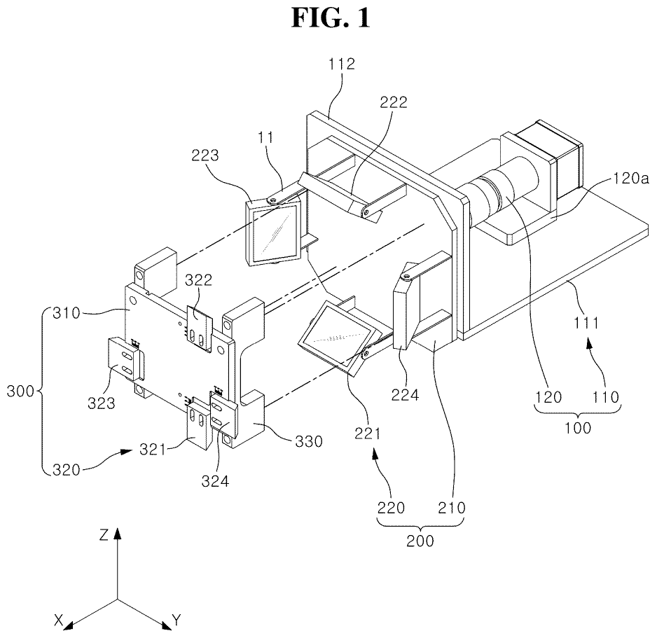

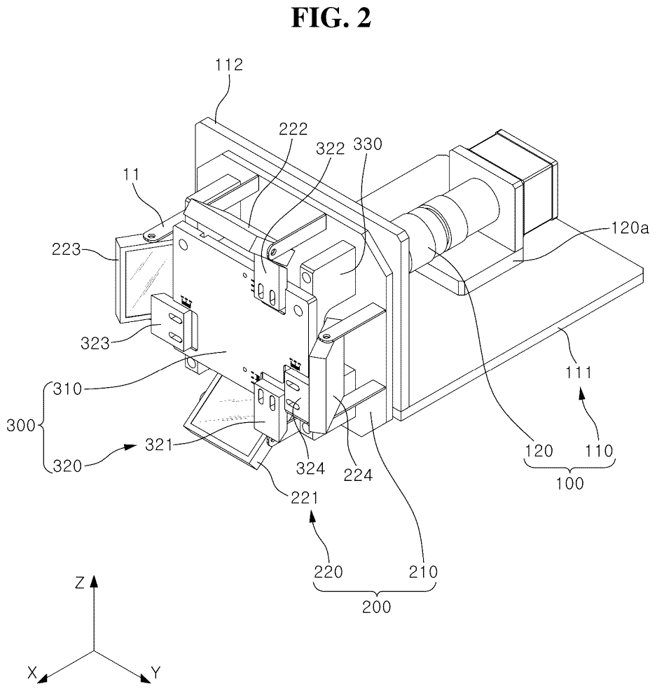

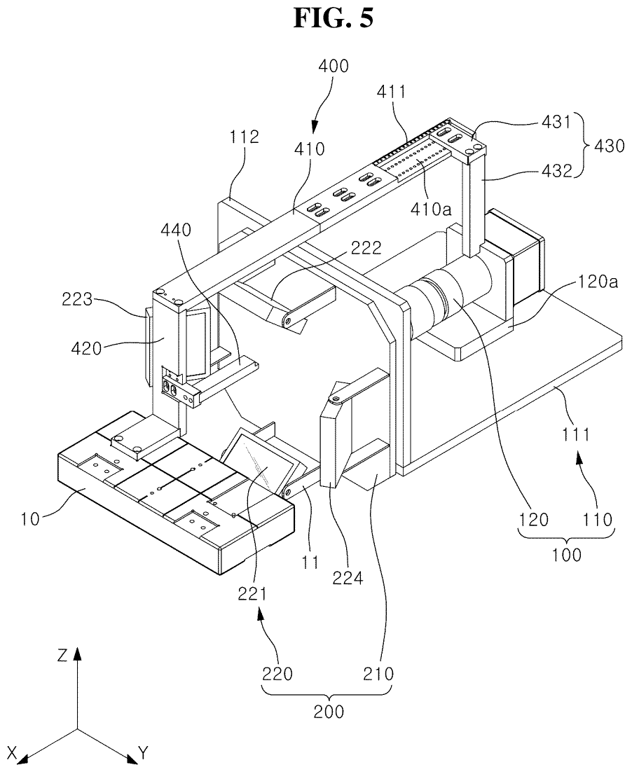

FIG. 1 is a perspective view schematically illustrating a configuration of a secondary battery inspection device according to embodiments of the present disclosure, FIG. 2 is a plan view schematically illustrating a configuration of the secondary battery inspection device according to embodiments of the present disclosure, and FIG. 5 is a perspective view schematically illustrating a configuration of the secondary battery inspection device according to embodiments of the present disclosure.

Referring to FIGS. 1, 2, and 5, the secondary battery inspection device according to the embodiment of the present disclosure may include a photographing unit 100, a lighting unit 200, an angle adjustment unit 300, and a position adjustment unit 400.

A first direction to be described herein may refer to an X-axis direction based on FIGS. 1 and 5, a second direction may refer to a Z-axis direction based on FIGS. 1 and 5, and a third direction may refer to a Y-axis direction based on FIGS. 1 and 5.

The photographing unit 100 may photograph a dummy battery cell 10. The dummy battery cell 10 simulates a secondary battery to inspect the secondary battery, and the dummy battery cell is a lithium-ion secondary battery and has a prismatic shape, which will be described as an example. However, the present disclosure is not limited thereto, and the secondary battery may be a lithium polymer battery or a cylindrical battery.

The photographing unit 100 may include a photographing main body 110 and a camera 120.

The photographing main body 110 may support the lighting unit 200. The photographing main body 110 may include a first main body 111 and a second main body 112.

The first main body 111 forms a bottom of the photographing main body 110, and may be formed to have a substantially plate shape. The camera 120 may be seated on the first main body 111. A cross-sectional shape of the first main body 111 is not limited to the quadrangular shape illustrated in FIG. 1 and may be designed to have various shapes such as polygonal, circular, oval, or other shapes.

The second main body 112 may be coupled to the first main body 111. The second main body 112 may be disposed to intersect the first main body 111. The second main body 112 may be formed to have a substantially plate shape. A cross-sectional shape of the second main body 112 is not limited to the quadrangular shape illustrated in FIG. 1 and may be designed to have various shapes such as polygonal, circular, oval, or other shapes.

The second main body 112 may be disposed between the first main body 111 and the lighting unit 200. The second main body 112 may be coupled to the lighting unit 200. The lighting unit 200 may be fixed to the second main body 112 by various types of coupling methods such as bolting, welding, fitting, etc.

The camera 120 may be coupled to the photographing main body 110. The camera 120 may include a charge coupled device (CCD). A photographing direction of the camera 120 may be directed in the first direction.

The camera 120 may be movably coupled to the first main body 111 along a direction parallel to the first direction. A moving block 120a supporting the camera 120 may be movably coupled to the first main body 111. For example, the moving block 120a may be coupled to the first main body 111 with a rail. The moving block 120a may be fixed to the first main body 111 by a coupling method such as bolting.

The camera 120 may be linearly moved in the first direction or a direction opposite to the first direction. The camera 120 may be disposed on the same axis as the dummy battery cell 10. The camera 120 may photograph a surface of the dummy battery cell 10 mounted on the position adjustment unit 400 to inspect the appearance of the dummy battery cell 10. Accordingly, the appearance of the secondary battery may be inspected.

The lighting unit 200 may be disposed between the photographing unit 100 and the dummy battery cell 10. The lighting unit 200 may irradiate light toward the dummy battery cell 10 mounted on the position adjustment unit 400. Accordingly, light may be irradiated toward the secondary battery.

The lighting unit 200 may include a lighting main body 210 and a lamp 220.

The lighting main body 210 may be disposed to face the angle adjustment unit 300 in the direction parallel to the first direction.

The lighting main body 210 may be supported by the photographing unit 100. The lighting main body 210 may be coupled to the second main body 112. The lighting main body 210 may be fixed to the second main body 112 by various types of coupling methods such as bolting, welding, fitting, etc.

The lighting main body 210 may be formed to have a substantially plate shape. A cross-sectional shape of the lighting main body 210 is not limited to the quadrangular shape illustrated in FIG. 1 and may be designed to have various shapes such as polygonal, circular, oval, or other shapes.

The lamp 220 may be rotatably coupled to the lighting main body 210. The lamp 220 may be disposed at an edge of the lighting main body 210.

The lamp 220 may be rotatably coupled to a bracket 11 provided on the lighting main body 210. The bracket 11 may protrude from the lighting main body 210 in the first direction. A cross-sectional shape of the lamp 220 is not limited to the quadrangular shape illustrated in FIG. 1 and may be designed to have various shapes such as polygonal, circular, oval, or other shapes.

The bracket 11 may be provided as a pair. The pair of brackets 11 may be disposed in parallel and spaced apart from each other. The lamp 220 may be disposed between the pair of brackets 11 and coupled to the bracket 11 through a hinge shaft to be tilted.

The lamp 220 may include a first lamp 221, a second lamp 222, a third lamp 223, and a fourth lamp 224.

The first lamp 221, the second lamp 222, the third lamp 223, and the fourth lamp 224 may be disposed spaced apart from each other along the edge of the lighting main body 210.

The first lamp 221 may irradiate light toward a lower side of the dummy battery cell 10. Accordingly, light may be irradiated to the lower side of the secondary battery.

The second lamp 222 may be spaced apart from the first lamp 221 in a direction parallel to the second direction. The second lamp 222 may be disposed to be spaced apart from the first lamp 221 in the second direction. The first lamp 221 and the second lamp 222 may be disposed in parallel. The second lamp 222 may irradiate light toward an upper side of the dummy battery cell 10. Accordingly, light may be irradiated to the upper side of the secondary battery.

The third lamp 223 may be disposed to cross the first lamp 221 and the second lamp 222.

The fourth lamp 224 may be spaced apart from the third lamp 223 in a direction parallel to the third direction. The fourth lamp 224 may be spaced apart from the third lamp 223 in the third direction. The third lamp 223 and the fourth lamp 224 may be disposed in parallel. Each of the third lamp 223 and the fourth lamp 224 may irradiate light toward both sides of the dummy battery cell 10. Accordingly, light may be irradiated to both sides of the secondary battery.

The angle adjustment unit 300 may be disposed between the lighting unit 200 and the dummy battery cell 10. The angle adjustment unit 300 may come into contact with the lighting unit 200 between the lighting unit 200 and the dummy battery cell 10 mounted on the position adjustment unit 400 to adjust an irradiation angle of the lighting unit 200.

When the adjustment of the irradiation angle of the lighting unit 200 is completed by the angle adjustment unit 300, the angle adjustment unit 300 may be removed from the secondary battery inspection device according to the present embodiment.

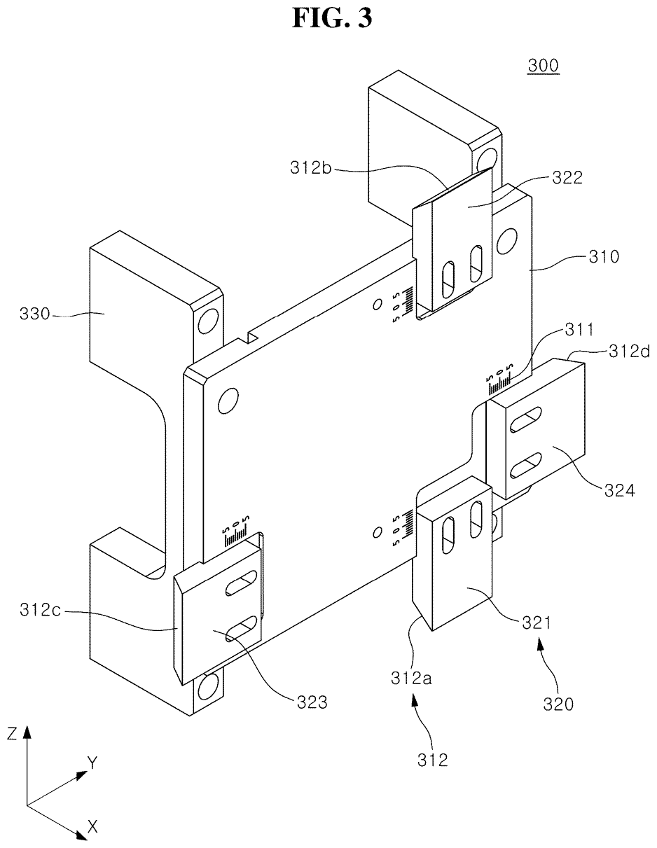

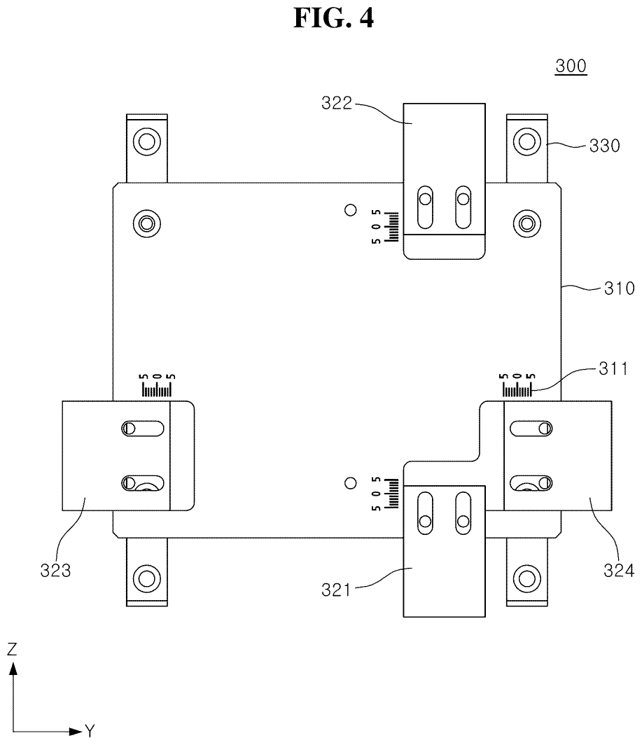

FIG. 3 is a perspective view schematically illustrating a configuration of the angle adjustment unit according to embodiments of the present disclosure and FIG. 4 is a front view schematically illustrating a configuration of the angle adjustment unit according to embodiments of the present disclosure.

Referring to FIGS. 1 to 4 and 5, the angle adjustment unit 300 according to the present embodiment may include an angle adjustment main body 310 and an angle adjustment block 320.

The angle adjustment main body 310 may be disposed to face the lighting main body 210. The angle adjustment main body 310 may be disposed to be spaced apart from the lighting main body 210 in the first direction.

The angle adjustment main body 310 may be formed to have a substantially plate shape. A cross-sectional shape of the angle adjustment main body 310 is not limited to the quadrangular shape illustrated in FIG. 4 and may be designed to have various shapes such as polygonal, circular, oval, or other shapes.

The angle adjustment block 320 may be movably coupled to the angle adjustment main body 310. The angle adjustment block 320 may be slidably coupled to the angle adjustment main body 310. For example, the angle adjustment block 320 may be coupled to the angle adjustment main body 310 with a rail to linearly reciprocate. The angle adjustment block 320 may be fixed to the angle adjustment main body 310 by a coupling method such as bolting.

The angle adjustment block 320 may come into contact with the lamp 220. The angle adjustment block 320 may be disposed at an edge of the angle adjustment main body 310. The angle adjustment block 320 may be disposed at a position corresponding to the lamp 220. The angle adjustment block 320 and the lamp 220 may be disposed to face each other.

The angle adjustment block 320 may come into contact with the lamp 220 to adjust the irradiation angle of the lamp 220.

The angle adjustment main body 310 may be provided with a first scale 311 for displaying the movement distance of the angle adjustment block 320. The first scale 311 may be printed or imprinted on the outer surface of the angle adjustment main body 310. The first scale 311 may be disposed on one side of the angle adjustment block 320.

An angle adjustment surface 312 may be provided in the angle adjustment block 320. The angle adjustment surface 312 may be formed to be inclined at a set angle on the outer surface of the angle adjustment block 320 facing the lamp 220.

The angle adjustment surface 312 may come into contact with the lamp 220. The angle adjustment surface 312 may adjust a rotation angle of the lamp 220.

As the angle adjustment main body 310 is moved in the direction opposite to the first direction and the lamp 220 comes into contact with the angle adjustment surface 312, the rotation angle of the lamp 220 may be adjusted to be the same as the inclination angle of the angle adjustment surface 312. Here, the rotation angle of the lamp 220 may refer to an irradiation angle of the lamp 220 and may refer to a tilting angle of the lamp 220.

A seating block 330 may be further provided on the angle adjustment main body 310. The seating block 330 may be disposed between the angle adjustment main body 310 and the lighting main body 210. The seating block 330 may be fixed to the angle adjustment main body 310 by various types of coupling methods such as bolting, welding, fitting, etc.

The seating block 330 may protrude from the angle adjustment main body 310 in the direction opposite to the first direction. The seating block 330 may come into contact with the lighting main body 210. The seating block 330 may be detachably coupled to the lighting main body 210. The seating block 330 may be temporarily fastened to the lighting main body 210 by a fastening member such as a bolt or the like.

The seating block 330 may be provided as a pair. The pair of seating blocks 330 may be spaced apart from each other and disposed in parallel.

The angle adjustment block 320 may include a first block 321, a second block 322, a third block 323, and a fourth block 324.

The first block 321, the second block 322, the third block 323, and the fourth block 324 may be disposed to be spaced apart from each other along the edge of the angle adjustment main body 310.

The first block 321 may be disposed to face the first lamp 221. The first block 321 may be disposed at a position corresponding to the first lamp 221 on the angle adjustment main body 310. The first block 321 may come into contact with the first lamp 221 to adjust the irradiation angle of the first lamp 221.

As an angle adjustment surface 312a of the first block 321 comes into contact with a light emitting surface of the first lamp 221, the rotation angle of the first lamp 221 may be adjusted.

The first block 321 may protrude in the direction parallel to the second direction. The first block 321 may protrude from the angle adjustment main body 310 in a direction opposite to the second direction.

As the first block 321 is slidingly moved in the second direction or in the direction opposite to the second direction on the angle adjustment main body 310, a protruding length of the first block 321 may be adjusted.

The second block 322 may be spaced apart from the first block 321 in the direction parallel to the second direction. The second block 322 may be spaced apart from the first block 321 in the second direction. The first block 321 and the second block 322 may be disposed in parallel.

The second block 322 may be disposed to face the second lamp 222. The second block 322 may be disposed at a position corresponding to the second lamp 222 on the angle adjustment main body 310. The second block 322 may come into contact with the second lamp 222 to adjust the irradiation angle of the second lamp 222.

As an angle adjustment surface 312b of the second block 322 comes into contact with a light emitting surface of the second lamp 222, the rotation angle of the second lamp 222 may be adjusted.

The second block 322 may protrude in the direction parallel to the second direction. The second block 322 may protrude from the angle adjustment main body 310 in the second direction.

As the second block 322 is slidingly moved in the second direction or in the direction opposite to the second direction in the angle adjustment main body 310, a protruding length of the second block 322 may be adjusted.

The third block 323 may be disposed to intersect the first block 321 and the second block 322.

The third block 323 may be disposed to face the third lamp 223. The third block 323 may be disposed at a position corresponding to the third lamp 223 on the angle adjustment main body 310. The third block 323 may come into contact with the third lamp 223 to adjust the irradiation angle of the third lamp 223.

As an angle adjustment surface 312c of the third block 323 comes into contact with a light emitting surface of the third lamp 223, the rotation angle of the third lamp 223 may be adjusted.

The third block 323 may protrude from the angle adjustment main body 310 in the direction parallel to the third direction. The third block 323 may protrude from the angle adjustment main body 310 in the direction opposite to the third direction.

As the third block 323 is slidingly moved in the third direction or in the direction opposite to the third direction in the angle adjustment main body 310, a protruding length of the third block 323 may be adjusted.

The fourth block 324 may be spaced apart from the third block 323 in the direction parallel to the third direction. The fourth block 324 may be disposed to be spaced apart from the third block 323 in the third direction. The third block 323 and the fourth block 324 may be disposed in parallel.

The fourth block 324 may be disposed to face the fourth lamp 224. The fourth block 324 may be disposed at a position corresponding to the fourth lamp 224 on the angle adjustment main body 310. The fourth block 324 may come into contact with the fourth lamp 224 to adjust the irradiation angle of the fourth lamp 224.

As an angle adjustment surface 312d of the fourth block 324 comes into contact with a light emitting surface of the fourth lamp 224, the rotation angle of the fourth lamp 224 may be adjusted.

The fourth block 324 may protrude in the direction parallel to the third direction. The fourth block 324 may protrude from the angle adjustment main body 310 in the third direction.

As the fourth block 324 is slidingly moved in the third direction or in the direction opposite to the third direction in the angle adjustment main body 310, a protruding length of the fourth block 324 may be adjusted.

The angle adjustment surfaces 312 respectively provided in the first block 321, the second block 322, the third block 323, and the fourth block 324 may be formed to have the same inclination angle or may be formed to have different inclination angles.

The first block 321, the second block 322, the third block 323, and the fourth block 324 may simultaneously come into contact with the first lamp 221, the second lamp 222, the third lamp 223, and the fourth lamp 224. Accordingly, the irradiation angles of the first lamp 221, the second lamp 222, the third lamp 223, and the fourth lamp 224 may be adjusted together.

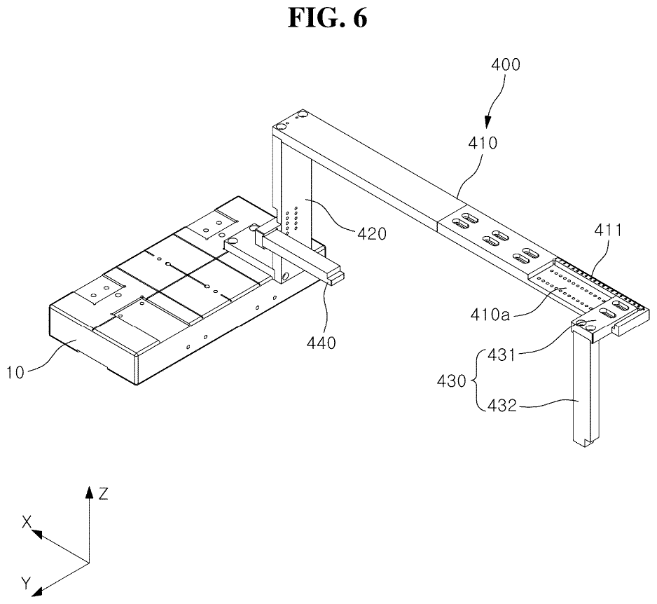

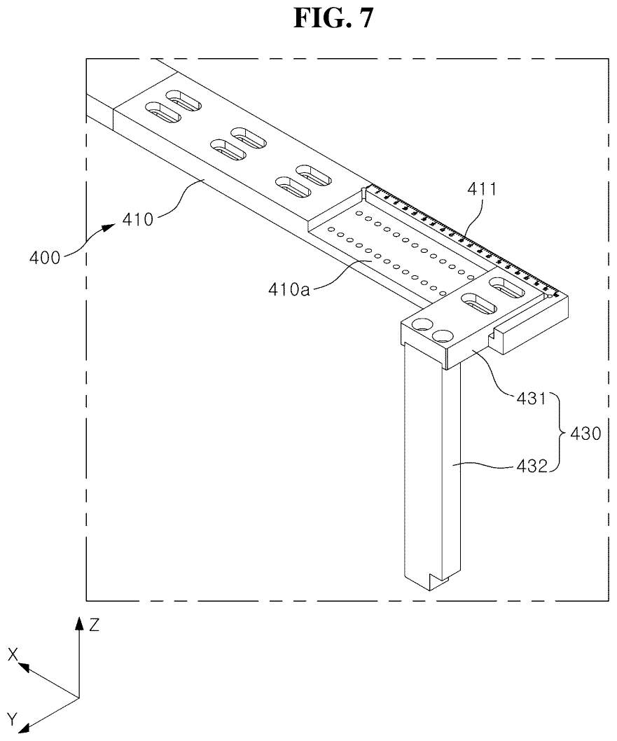

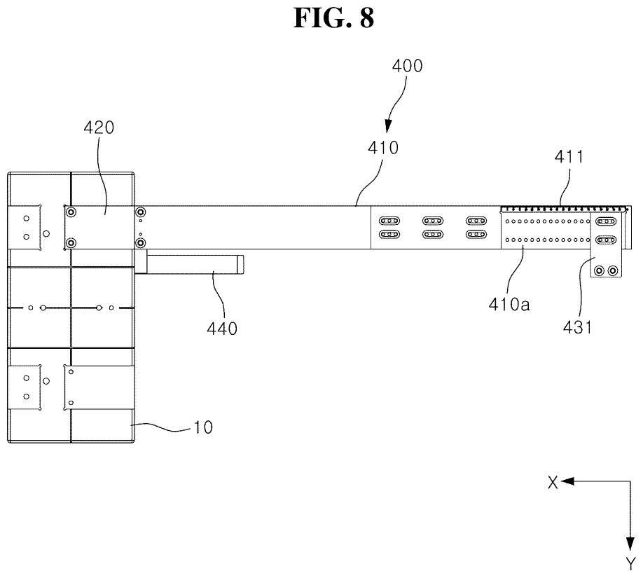

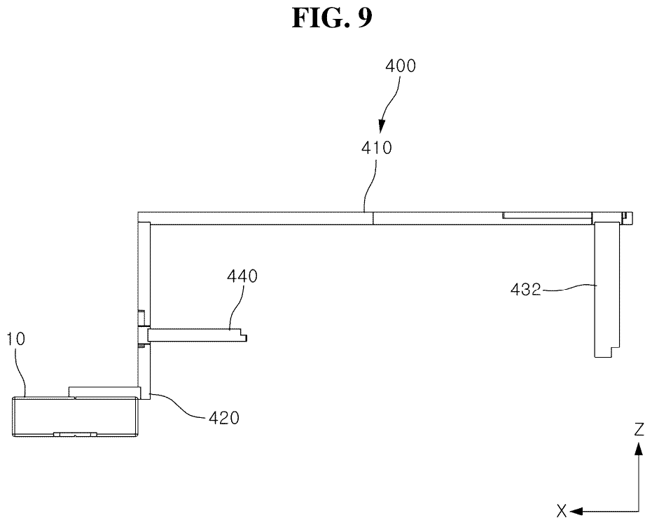

FIG. 6 is a perspective view schematically illustrating a configuration of a position adjustment unit according to embodiments of the present disclosure, FIG. 7 is a partially enlarged perspective view schematically illustrating a configuration of the position adjustment unit according to embodiments of the present disclosure, FIG. 8 is a plan view schematically illustrating a configuration of the position adjustment unit according to embodiments of the present disclosure, and FIG. 9 is a side view schematically illustrating a configuration of the position adjustment unit according to embodiments of the present disclosure.

Referring to FIGS. 5 to 9, the position adjustment unit 400 according to the present embodiment may be connected to the dummy battery cell 10. The position adjustment unit 400 may adjust the position of the photographing unit 100 by interfering with the photographing unit 100.

When the position of the photographing unit 100 is adjusted by the position adjustment unit 400, the position adjustment unit 400 may be removed from the secondary battery inspection device according to the present embodiment.

The position adjustment unit 400 may include a first frame 410, a second frame 420, and a third frame 430.

The first frame 410 may be formed approximately in the shape of a bar or rod having a set length. The first frame 410 may be coupled to the photographing main body 110.

The first frame 410 may be disposed in a direction parallel to the first direction, and may be detachably coupled to the second main body 112 in a state of being seated on the second main body 112. The first frame 410 may be fixed to the second main body 112 by a coupling method such as bolting.

The second frame 420 may be connected to the first frame 410. The second frame 420 may be formed approximately in the shape of a bar or rod having a set length.

The second frame 420 may be disposed to intersect the first frame 410. The second frame 420 may be disposed in the direction parallel to the second direction. The second frame 420 may extend from one side of the first frame 410 in the direction opposite to the first direction.

The dummy battery cell 10 may be coupled to the second frame 420. A bracket coupled to the dummy battery cell 10 may be detachably coupled to an end portion of the second frame 420.

The third frame 430 may be disposed to be spaced apart from the second frame 420. The third frame 430 may be disposed to be spaced apart from the second frame 420 in the direction opposite to the first direction. The third frame 430 may be provided on the other side of the first frame 410.

The third frame 430 may be formed approximately in the shape of a bar or rod having a set length. The third frame 430 may come into contact with the camera 120.

The third frame 430 may be movably coupled to the first frame 410. The third frame 430 may be slidably coupled to the first frame 410. For example, the third frame 430 may be coupled to the first frame 410 with a rail to linearly reciprocate.

The first frame 410 may be provided with a recessed surface 410a formed in the outer surface thereof. The recessed surface 410a may be formed in the direction parallel to the first direction. In a state in which the third frame 430 is seated on the recessed surface 410a, the third frame 430 may linearly reciprocate in the direction parallel to the first direction.

The third frame 430 may include a connection bar 431 and a contact bar 432.

The connection bar 431 may be disposed to intersect the first frame 410 in the direction parallel to the third direction. The connection bar 431 may protrude from the other side of the first frame 410 in the third direction.

The connection bar 431 may be seated on the recessed surface 410a to linearly reciprocate in the direction parallel to the first direction. The connection bar 431 may be fixed to the first frame 410 by a coupling method such as bolting.

The contact bar 432 may be connected to the connection bar 431. The contact bar 432 may come into contact with the camera 120 to interfere with the camera 120.

The contact bar 432 may be disposed to intersect the connection bar 431. The contact bar 432 may extend from an end portion of the connection bar 431 in the direction opposite to the second direction. The end portion of the contact bar 432 may interfere with the camera 120, thereby limiting the movement of the camera 120 in the first direction.

Since the third frame 430 slides linearly in the direction parallel to the first direction on the first frame 410, and the movement of the camera 120 in the first direction is limited by the interference of the third frame 430, the separation distance between the dummy battery cell 10 and the camera 120 may be adjusted and thus according to the size of the dummy battery cell 10, the focus of the camera 120 photographing the dummy battery cell 10 may be adjusted.

The first frame 410 may be provided with a second scale 411 for displaying the movement distance of the third frame 430. The second scale 411 may be printed or imprinted on the outer surface of the first frame 410. The second scale 411 may be disposed on one side of the recessed surface 410a. The second scale 411 may be disposed in parallel with the recessed surface 410a.

The position adjustment unit 400 according to the present embodiment may further include a fourth frame 440. The fourth frame 440 may be movably coupled to the second frame 420.

The fourth frame 440 may be formed approximately in the shape of a bar or rod having a set length. The fourth frame 440 may be disposed to intersect the second frame 420.

The fourth frame 440 may be disposed in the direction parallel to the first direction. The fourth frame 440 may be disposed between the second frame 420 and the third frame 430. The fourth frame 440 may be slidably coupled to the second frame 420 and may linearly reciprocate in the direction parallel to the second direction. For example, the fourth frame 440 may be coupled to the second frame 420 with a rail to linearly reciprocate.

According to one embodiment of the present disclosure, the irradiation angle of a lamp irradiating light toward a secondary battery can be adjusted by the configuration of an angle adjustment unit coming into contact with the lamp.

According to embodiments of the present disclosure, the focus of a camera photographing the appearance of a secondary battery can be adjusted by the configuration of a position adjustment unit that interferes with the camera to limit the movement of the camera.

However, the effects obtained through the present disclosure are not limited to the herein-described effects, and other technical effects that are not mentioned will be clearly understood by those skilled in the art from the description of the disclosure described herein.

Although the present disclosure has been described with reference to the embodiments shown in the drawings, these are merely exemplary, and it should be understood by those skill in the art that various modifications and equivalents are possible.

The present disclosure has been described with reference to embodiments illustrated in the drawings, which are merely exemplary, and those having ordinary skill in the art will understand that various modifications and equivalent other embodiments are possible.

What is claimed is:

1. A secondary battery inspection device comprising:
a photographing unit photographing a dummy battery cell;
a lighting unit disposed between the photographing unit and the dummy battery cell and irradiating light toward the dummy battery cell; and
an angle adjustment unit disposed between the lighting unit and the dummy battery cell and coming into contact with the lighting unit to adjust an irradiation angle of the lighting unit.

2. The secondary battery inspection device of claim 1, wherein the lighting unit includes:
a lighting main body disposed to face the angle adjustment unit in a direction substantially parallel to a first direction and supported by the photographing unit; and
a lamp rotatably coupled to the lighting main body.

3. The secondary battery inspection device of claim 2, wherein the lamp includes:
a first lamp; and
a second lamp disposed to be spaced apart from the first lamp in a direction substantially parallel to a second direction intersecting the first direction.

4. The secondary battery inspection device of claim 3, wherein the lamp further includes:
a third lamp disposed to intersect the first lamp and the second lamp; and
a fourth lamp disposed to be spaced apart from the third lamp in a direction substantially parallel to a third direction intersecting the first direction and the second direction.

5. The secondary battery inspection device of claim 2, wherein the angle adjustment unit includes:
an angle adjustment main body disposed to face the lighting main body; and
an angle adjustment block movably coupled to the angle adjustment main body and contactable with the lamp.

6. The secondary battery inspection device of claim 5, wherein the angle adjustment main body is provided with a first scale indicating a movement distance of the angle adjustment block.

7. The secondary battery inspection device of claim 5, wherein the angle adjustment block is provided with an angle adjustment surface that comes into contact with the lamp to adjust a rotation angle of the lamp.

8. The secondary battery inspection device of claim 7, wherein the angle adjustment surface is formed obliquely on an outer surface of the angle adjustment block.

9. The secondary battery inspection device of claim 5, wherein the angle adjustment block includes:
a first block; and
a second block disposed to be spaced apart from the first block in a direction substantially parallel to a second direction intersecting the first direction.

10. The secondary battery inspection device of claim 9, wherein the first block and the second block protrude from the angle adjustment main body in the direction substantially parallel to the second direction.

11. The secondary battery inspection device of claim 9, wherein the angle adjustment block further includes:
a third block disposed to intersect the first block and the second block; and
a fourth block disposed to be spaced apart from the third block in a direction substantially parallel to a third direction intersecting the first direction and the second direction.

12. The secondary battery inspection device of claim 11, wherein the third block and the fourth block protrude from the angle adjustment main body in the direction substantially parallel to the third direction.

13. The secondary battery inspection device of claim 1, further comprising a position adjustment unit connected to the dummy battery cell and interfering with the photographing unit to adjust a position of the photographing unit.

14. The secondary battery inspection device of claim 13, wherein the photographing unit includes:
a photographing main body supporting the lighting unit; and
a camera movably coupled to the photographing main body in a direction substantially parallel to a first direction.

15. The secondary battery inspection device of claim 14, wherein the position adjustment unit includes:
a first frame coupled to the photographing main body;
a second frame connected to the first frame and coupled to the dummy battery cell; and
a third frame disposed to be spaced apart from the second frame, movably coupled to the first frame in the direction substantially parallel to the first direction, and contactable with the camera.

16. The secondary battery inspection device of claim 15, wherein the first frame is provided with a second scale indicating a movement distance of the third frame.
